(19) United States
(12) Patent Application Publication
(10) Pub. No.: US 2004/0229668 A1
(43) Pub. Date: Nov. 18, 2004

(54) Kiln formed glass decorated casing for cellular phone

(76) Inventor: Chih Kang Lin, Taipei (TW)

Correspondence Address: Chih Kang Lin, PO Box 82-144, Taipei, TW

(21) Appl. No.: 10/437,288

(22) Filed: May 14, 2003

(51) Int. Cl. H04Q 7/20

(52) U.S. Cl. 455/575.3; 455/575.1; 455/90.3

(57) ABSTRACT

A kiln formed glass decorated casing for cellular phone is constructed to include a casing for cellular phone, the casing having a recessed portion in the outside wall, and a sheet of kiln formed glass member peripherally packed with a metal packing material and bonded with the metal packing material to the recessed portion in flush with the outside wall of the casing.

### BACKGROUND OF THE INVENTION

1. Field of the Invention

The present invention relates to cellular phones and, more specifically, to a kiln formed glass decorated casing for cellular phone.

2. Description of the Related Art

A variety of cellular phones are commercially available. In order to attract consumers' attention, the casing of a cellular phone is decorated with design. There are cellular phones having a replaceable cover shell. Because the designs in the casings of conventional cellular phones are plain designs directly printed on the metal or plastic casings, they are less attractive. There are also known cellular phones having ornamental metal strips embedded in the cover shell.

### SUMMARY OF THE INVENTION

The present invention has been accomplished under the circumstances in view. It is one object of the present invention to provide a casing for cellular phone, which attracts consumers' attention. It is another object of the present invention to provide a casing for cellular phone, which produces a color lighting effect when radiated by light. To achieve these and other objects of the present invention, a kiln formed glass decorated casing for cellular phone is provided, comprising a casing, the casing having a recessed portion in the outside wall, and a sheet of kiln formed glass member peripherally packed with a metal packing material and bonded with the metal packing material to the recessed portion in flush with the outside wall of the casing.

### BRIEF DESCRIPTION OF THE DRAWINGS

FIG. 1 is an exploded view in section of a kiln formed glass decorated casing for cellular phone according to the present invention.

FIG. 2 is an assembly view of FIG. 3.

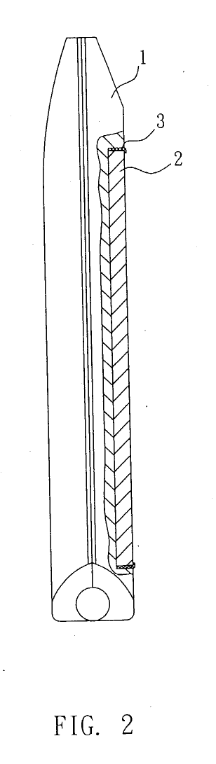

FIG. 3 is a front plain view of FIG. 2.

### DETAILED DESCRIPTION OF THE PREFERRED EMBODIMENT

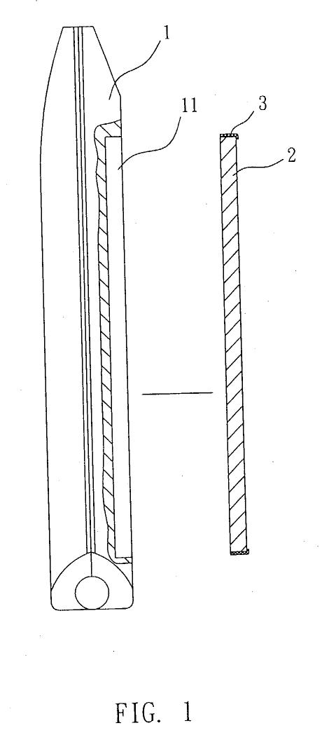

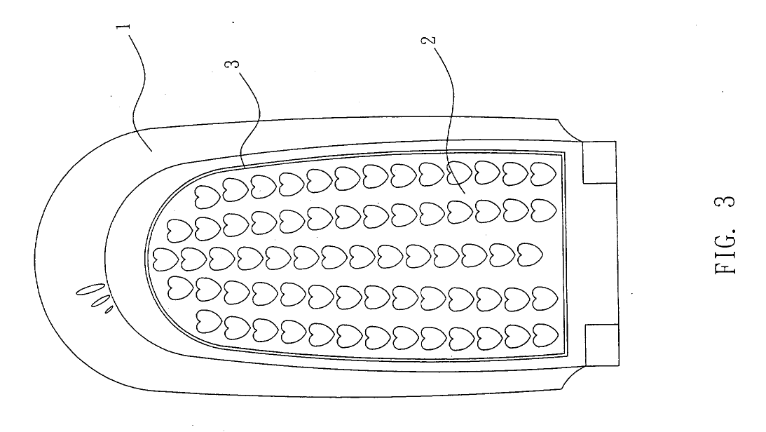

Referring to FIGS. 1˜3, the casing 1 for cellular phone has a recessed portion 11 in the outside wall at a suitable location. A sheet of kiln formed glass 2 is bonded to the recessed portion 11. The sheet of kiln formed glass 2 has a color design in it. FIG. 3 shows an example of the color design formed of a number of hearts. The sheet of kiln formed glass 2 can be made having a fine color design. However, it is difficult to make the contour of the sheet of kiln formed glass 2 that fits the contour of the recessed portion 11 perfectly. In order to eliminate this problem, a packing metal material 3 is covered on the periphery of the sheet of kiln formed glass 2, and fitted with the sheet of kiln formed glass 2 into the recessed portion 11. Before mounting, a bonding agent is applied to the recessed portion 11, and then the sheet of kiln formed glass 2 is fitted with the packing metal material 3 into the recessed portion 11. When installed, the kiln formed glass 2 is maintained in flush with the outside wall of the casing 1. The packing metal material is preferably obtained from titanium alloy or stainless steel that is rustless, and causes a sense of beauty. When radiated by light, the sheet of kiln formed glass 2 reflects light in different directions, producing a colorful lighting effect.

FIGS. 1˜3 show an installation example of the sheet of kiln formed glass in the outside wall of the front cover of a folding cellular phone, which front cover has a display screen and a keypad on the inside. For a cellular phone having the display screen and the keypad located on the outside wall of the casing, small chips of kiln formed glass may be installed in the outside wall of the casing around the display screen and the keypad.

A prototype of kiln formed glass decorated casing for cellular phone has been constructed with the features of FIGS. 1˜3. The kiln formed glass decorated casing for cellular phone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A kiln formed glass decorated casing for cellular phone, comprising:
a casing, said casing having at least one recessed portion in an outside wall thereof; and
at least one ornamental kiln formed glass member respectively fastened to said at least one recessed portion in flush with the outside wall of said casing, said at least one ornamental kiln formed glass member each comprising a flat piece of kiln formed glass and a packing metal material covering the periphery of said flat piece of kiln formed glass.

2. The kiln formed glass decorated casing for cellular phone as claimed in claim 1, further comprising a bonding agent applied to said at least one recessed portion and said at least one ornamental kiln formed glass member to secure said at least one ornamental kiln formed glass member to said at least one recessed portion.
